(19) United States
(12) Patent Application Publication
(10) Pub. No.: US 2019/0196300 A1
(43) Pub. Date: Jun. 27, 2019

(54) OIS ACTUATOR HAVING INTEGRATED YOKE

(71) Applicant: JAHWA electronics Co., Ltd., Chungcheongbuk-do (KR)

(72) Inventors: Hee Seoung KIM, Seoul (KR); In Soo KIM, Gyeonggi-do (KR); Seung Hwan CHOI, Gyeonggi-do (KR)

(21) Appl. No.: 16/304,411

(22) PCT Filed: May 12, 2017
(86) PCT No.: PCT/KR2017/004937

§ 371 Date: Nov. 26, 2018

(30) Foreign Application Priority Data
Jun. 15, 2016 (KR) 10-2016-0074693

(51) Int. Cl. G03B 5/00; G02B 27/64; H02K 11/215; H02K 41/035

(52) U.S. Cl. CPC G03B 5/00; G02B 27/646; G03B 2205/0069; H02K 41/0356; G03B 2205/0007; H02K 11/215

(57) ABSTRACT

An optical image stabilization (OIS) actuator having an integrated yoke includes a base frame; an OIS carrier disposed on the base frame so that a lens barrel is to be coupled thereto; first and second magnets respectively provided to the OIS carrier in a first direction and a second direction, which are orthogonal to each other; first and second coils respectively provided to face the first and second magnets to generate an electromagnetic force to the first and second magnets; a ball interposed between the base frame and the OIS carrier; and a yoke formed integrally and provided to the base frame at a location corresponding to the first and second magnets to generate an attractive force to the first and second magnets.

### TECHNICAL FIELD

The present disclosure relates to an OIS actuator, and more particularly, to an OIS actuator having an integrated yoke with an improved yoke structure for generating an attractive force to an OIS magnet.

### BACKGROUND ART

As the hardware technology for image processing has been developed and the user needs for image shooting have increased, functions such as autofocus (AF) and optical image stabilization (OIS) have been applied to a camera module or the like, mounted to a portable terminal such as a cellular phone and a smart phone as well as an independent camera device.

In an environment where a subject and its surroundings are not sufficiently bright, for example in a dark space or at a night time, a relatively long exposure is necessary in order to transmit a sufficient amount of light to an image sensor.

If a long exposure is performed as described above, lens shaking may be reflected on an image for a longer time, which affects the definition (sharpness) of the image, thereby rumpling or blurring the image.

In addition, in the case of a camera module mounted to a mobile terminal such as a smart phone, the terminal is moved greatly, and the hand and arm tremors generated in the human body may be easily transferred to the camera module. Also, since a user uses the camera module more often while moving such as walking, riding a vehicle or the like, such image blurring occurs more frequently. Further, in recent years, a selfie stick is more often used when a user uses photographs an image of himself/herself as a subject. In this case, the length of the selfie stick is added to the length of the arm of the user who physically supports the mobile terminal, and thus the image is blurred more due to shaking or vibrations.

The stabilization technology is to overcome this phenomenon. Typically, the stabilization technology includes digital image stabilization (DIS) and electronic image stabilization (EIS), which improve an image quality through processing through software or the like with respect to a photographed image, and optical image stabilization (OIS) for preventing an image of a subject generated at an image sensor from being blurred by physically changing a position of a lens or an image element to correct camera shaking or the like.

An OIS actuator for performing the image stabilization function is implemented not only as a single driving device for performing only the image stabilization function but also as an integrated driving device for performing an auto focus (AF) function together. The integrated driving device may be implemented such that an OIS function is performed at an inner side or an upper side of an AF carrier that performs an AF function, or such that an AF function is performed at an inner side or an upper side of an OIS carrier that performs an OIS function, depending on its implementation types.

Recently, the OIS actuator may also include a ball between the OIS carrier (a moving body) and the housing (a fixed body), which move in a direction perpendicular to the optical axis, in order to minimizes the frictional force by means of a point contact with the ball and induce more flexible movement of the OIS carrier by means of rolling motion of the ball.

In the conventional OIS actuator, an OIS magnet provided at the OIS carrier and a yoke means for generating an attractive force may be provided in the housing (a fixed body) so that the OIS carrier does not deviate but maintains the point contact with the ball.

Conventionally, a plurality of yoke means are provided in a number corresponding to the OIS magnets. If the plurality of individual yoke means are mounted to the housing, the assembling process becomes difficult, and the space for mounting the individual yokes should be reflected on the actuator design, thereby complicating the actuator design. In addition, the individual yokes and the corresponding magnets should be aligned with each other, thereby complicating the aligning process.

Also, if the plurality of individual yoke means are used as in the conventional art, the attractive force with respect to the magnets provided at the OIS carrier is not significantly generated, and thus the OIS carrier may deviate from the ball just by a small impact or vibration, thereby deteriorating the precision of the OIS operation.

### DISCLOSURE

### Technical Problem

The present disclosure is designed to solve the problems of the related art, and therefore the present disclosure is directed to providing an OIS actuator, which may generate a sufficient attractive force with OIS magnets so that an OIS carrier effectively maintains a point contact with a ball without deviating from the ball due to external environment such as shock and vibration as well as OIS operation even though the OIS carrier moves by OIS operation, and which may more effectively improve an assembling process or the like.

These and other objects and advantages of the present disclosure may be understood from the following detailed description and will become more fully apparent from the exemplary embodiments of the present disclosure. Also, it will be easily understood that the objects and advantages of the present disclosure may be realized by the means shown in the appended claims and combinations thereof

### Technical Solution

In one aspect of the present disclosure, there is provided an optical image stabilization (OIS) actuator having an integrated yoke, comprising: a base frame; an OIS carrier disposed on the base frame so that a lens barrel is coupled thereto; first and second magnets respectively provided to the OIS carrier in a first direction and a second direction, which are orthogonal to each other; first and second coils respectively provided to face the first and second magnets to generate an electromagnetic force to the first and second magnets; a ball interposed between the base frame and the OIS carrier; and a yoke formed integrally and provided to the base frame at a location corresponding to the first and second magnets to generate an attractive force to the first and second magnets.

Here, the yoke of the present disclosure may include a first part corresponding to a region of the first magnet; a second part corresponding to a region of the second magnet; and a connection part connecting the first part and the second part.

Also, the first part and the second part of the yoke according to the present disclosure may be shaped corresponding to facing surfaces of the first and second magnets, respectively, and the first part and the second part of the yoke according to the present disclosure may be shaped different from the connection part

Further, the OIS carrier according to the present disclosure may have a coupling hole formed at a location deviating from a center portion thereof so that the lens barrel is coupled therein, and in this case, the first and second magnets of the present disclosure may be provided at a side opposite to the coupling hole.

In this case, the first magnet of the present disclosure may include two magnets symmetrical to each other based on the first direction, and here, the second magnet of the present disclosure may be provided between the two first magnets.

In addition, the first part and the second part of the yoke may have different heights to form a step therebetween.

### Advantageous Effects

According to an embodiment of the present disclosure, a sufficient attractive force may be generated by implementing the yoke in an integrated type, and the attractive force may be effectively generated throughout a magnet moving region by means of the OIS operation. Thus, the OIS carrier may effectively maintain the point contact with the ball without deviating from the ball due to an external environment such as shock or vibration environment as well as the OIS operation, thereby further improving the OIS operation performance.

In addition, in the present disclosure, since the OIS magnet and the yoke generating an attractive force are not individually provided but are integrally implemented and provided to the base frame (a fixed body), the efficiency of the process of mounting the yoke to the base frame may be enhanced, compared to the conventional process in which a plurality of individual yokes are mounted separately. In addition, the yoke may be aligned with the magnet more accurately and easily.

According to another embodiment of the present disclosure, the yoke may be integrally implemented so that its portion corresponding to a direction perpendicular to the optical axis is stepped, thereby maintaining the reliability of the OIS operation and further enhancing its expandability.

### BRIEF DESCRIPTION OF THE DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a diagram showing an outer appearance of an OIS actuator according to an embodiment of the present disclosure,

FIG. 2 is an exploded view showing a detailed configuration and a coupling relationship of the OIS actuator according to an embodiment of the present disclosure,

FIG. 3 is a diagram showing a detailed configuration of the yoke of the present disclosure, depicted in FIG. 2,

FIG. 4 is a diagram showing a yoke according to another embodiment of the present disclosure, and

FIG. 5 is a diagram showing an OIS actuator according to still another embodiment of the present disclosure.

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

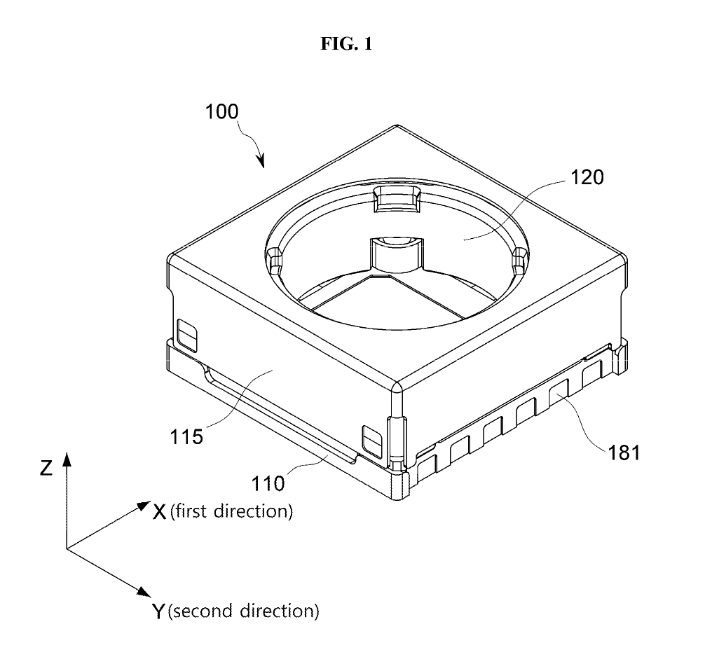

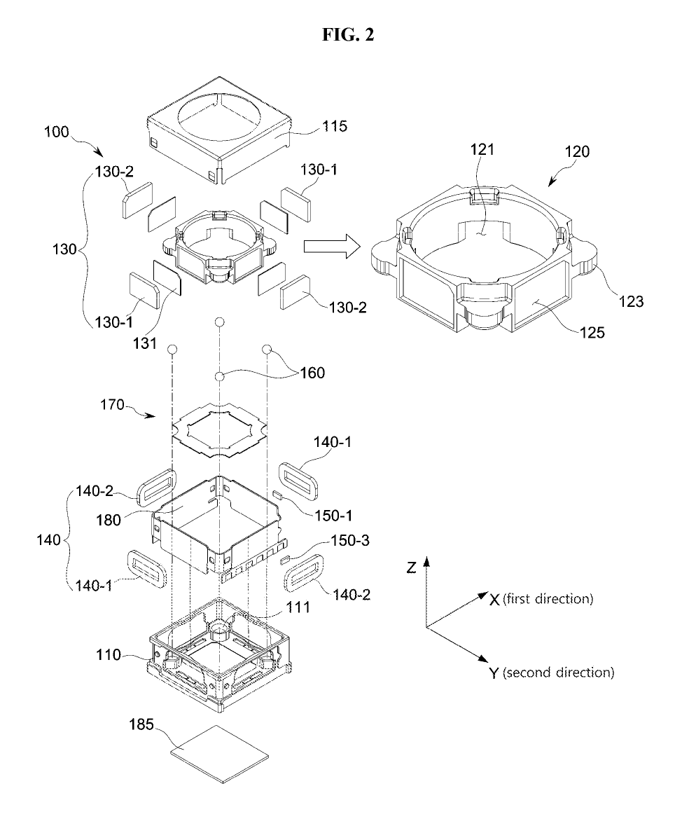

An OIS actuator (hereinafter referred to as ‘actuator’) 100 having an integrated yoke according to the present disclosure is an actuator or a driving device for image stabilization. As shown in FIGS. 1 and 2, the actuator 100 may include a base frame 110, an OIS carrier 120, a magnet 130, a coil 140, a hall sensor 150, a ball 160, and a yoke 170.

As shown in FIG. 1 showing an outer appearance of the actuator 100 of the present disclosure, the actuator 100 of the present disclosure may include a base frame 110 having an inner space formed therein to accommodate components of the present disclosure and a shield can 115 coupled above the base frame 100 to make insulation from an upper case and the outside.

As explained later, the actuator 100 of the present disclosure may input and output signals or date with a drive chip (not shown) for position feedback control or a device (a smart phone or the like) to which the actuator 100 of the present disclosure is mounted, and a driving power is applied thereto from the outside. Thus, a terminal 181 of a (flexible) circuit board 180 is preferably exposed out of the base frame 110 for effectively interfacing power, signals, data or the like.

As shown in the figures, the Z axis is an axial direction indicating an optical axis, and means a direction in which a lens (or, a lens barrel or a lens assembly) moves linearly for focus adjustment or the like. The X axis and the Y axis mean two axial directions perpendicular to the optical axis. In the following description, a first direction and a second direction refer to two axial directions on the X-Y plane perpendicular to the optical axis, and the first and second directions are orthogonal to each other.

The base frame 110 of the present disclosure gives a space in which the OIS carrier 120 moves in the first and/or second directions perpendicular to the optical axis. Considering that the OIS carrier 120 corresponds to a moving body moving in a direction perpendicular to the optical axis, the base frame 110 corresponds to a fixed body relative to the OIS carrier 120.

Thus, in the case of a driving device or an actuator in which only the OIS function is implemented, as shown in FIGS. 1 and 2, the base frame 110 may be a frame corresponding to a case of the actuator, like a housing. In addition, in the case of a driving device in which the OIS carrier 120 is located inside or above an AF carrier moving in the optical axis direction so that the AF function and the OIS function are implemented integrally, the AF carrier may correspond to the base frame 110 of the present disclosure.

That is, if an object supports the movement of the OIS carrier 120 moving in a direction perpendicular to the optical axis direction and gives a moving space therefor, the object should be interpreted as corresponding to the base frame 110 of the present disclosure regardless of its name.

As shown in FIG. 2, the OIS carrier 120 of the present disclosure has a coupling hole or a coupling space 121 at a center portion thereof, and a lens barrel (not shown) may be coupled through the coupling hole 121. By this coupling, the OIS carrier 120 of the present disclosure physically moves together with the lens barrel.

The magnet 130 of the present disclosure is mounted to the OIS carrier 120. If a power of appropriate magnitude and direction is applied to the coil 140 by the feedback control corresponding to the position correction, an electromagnetic force is generated at the coil 140, and the electromagnetic force is transferred to the magnet 130 so that the OIS carrier 120 moves.

As described above, since the OIS carrier 120 may move in combination of the first direction and the second direction, the magnet 130 includes a first magnet 130-1 provided at a position corresponding to the first direction and a second magnet 130-2 provided at a position corresponding to the second magnet 130-2, according to the moving directions.

If the OIS carrier 120 is movable in the first and second directions, one magnet 130 may be respectively provided in the first direction and the second direction. Alternatively, it is also possible that two magnets are respectively provided in the first direction and the second direction as shown in FIG. 1, or one magnet is provided in a specific direction and two magnets are provided in the other specific direction, depending on embodiments.

The magnets 130 may be provided at four side surfaces of the OIS carrier 120 as shown in the figures, and may be provided on an outer portion of the bottom of the OIS carrier 120, depending on embodiments. Meanwhile, a back yoke 131 may be further provided at a back surface of the magnet 130, namely at a side opposite to the coil, in order to prevent the magnetic force from being leaked and concentrate the magnetic force.

The coil 140 of the present disclosure is to generate an electromagnetic force to the magnet 130, and may include a first coil 140-1 and a second coil 140-2 respectively located to face the first magnet 130-1 and the second magnet 130-2. The coil 140 is provided at the base frame 110 of the present disclosure.

The coil 140 may have a wound form with a space at the center portion thereof, and the first coil 140-1 and/or the second coil 140-2 may be implemented in a dual form, depending on embodiments.

The first hall sensor 150-1 and the second hall sensor 150-3 of the present disclosure sense the position of the OIS carrier 120 (specifically, the positions of the first magnet 130-1 and the second magnet 130-2) based on the first and second directions, respectively, by using the hall effect and output the sensing value.

A drive chip or module (not shown) that may be provided at the outside may function to control the magnitude or direction of the power respectively applied to the first coil 140-1 and the second coil 140-1 provided in the first direction and the second direction according to the sensing values of the hall sensors 150-1, 150-3.

In order to further improve the space utilization, the hall sensors 150-1, 150-3 may be provided in the space at the center portion of the coil 140, when the coil 140 is implemented to have a wound form.

The magnitude and direction of the power applied to the first coil 140-1 and the second coil 140-2 respectively provided in the first direction and the second direction are determined by the values outputted by the hall sensors 150-1, 150-3, and an electromagnetic force corresponding thereto is generated. Thus, the OIS carrier 120 is functionally influenced by the electromagnetic force to move in the first direction or the second direction, or in a combined direction. Since sensing the positions of the hall sensors 150-1, 150-3 in each direction, controlling the applied power to generate an electromagnetic force according to the sensed result, and moving the OIS carrier 120 accordingly may be performed through cyclic processing, the position of the carrier 120 is accurately feedback-controlled.

The actuator 100 according to the present disclosure includes a ball 160 interposed between the OIS carrier 120 and the base frame 110 as shown in the figures.

The OIS carrier 120 of the present disclosure is placed on the ball 160 to make at a point contact at the top of the ball 160 and moves in the XY plane direction, namely in the first direction and/or in the second direction, on the ball 160. Thus, the OIS carrier 120 may move smoothly with a minimized frictional force due to the point contact with the ball and the rolling motion of the ball.

For the implementation of the more preferred embodiment, as shown in FIG. 2, a support plate 123 having a bottom surface in contact with the ball may be provided at a corner of the OIS carrier 120. Considering the distance between the OIS carrier 120 and the bottom surface of the base frame 110 and the resultant attractive force between the magnet 130 and the yoke 170, the support plate 123 is preferably provided at a position higher than the lowermost end of the OIS carrier 120 based on the vertical height.

In addition, an accommodation groove 111 may be provided at a lower portion of the base frame 110 to accommodate a part of the ball 160 at a position corresponding to the support plate 123 to prevent the ball 160 from deviating.

In order to more precisely control the position of the OIS carrier 120 by the OIS operation, it is desirable that the OIS carrier 120 continuously maintains the point contact with the ball 160 and does not deviate from the ball 160.

The yoke 170 of the present disclosure is provided at the base frame 110 as shown in the figures and is provided at a position corresponding to the position of the magnet 130. The yoke 170 is a magnetic body such as a metal and generates an attractive force to the magnet 130 provided at the OIS carrier 120 separated by the ball 160. Thus, the OIS carrier 120 continuously makes point contact with the ball 160 without deviating therefrom due to the attractive force.

In this regard, conventionally, the yoke 170 is provided at a position corresponding to the magnet, but a plurality of individualized yokes corresponding to the number of the provided magnets are mounted to a fixed body, respectively.

However, according to this method, since the yokes should be mounted at the correct positions individually, the process efficiency is low. Also, since the magnetic force generated as a whole is not large in relation to the magnet, the OIS carrier 120 having the magnet 130 deviates from the ball just by a small impact or shaking, and the OIS operation is not precisely performed due to this phenomenon.

In addition, if the OIS carrier 120 is moved due to the hand shaking or is moved reversely to compensate for the hand shaking, the position of the magnet 130 provided at the OIS carrier 120 is also changed. At this time, the alignment of the magnet 130 and the yoke 170 is collapsed due to the position change, and the attractive force between the magnet 130 and the yoke 170 is weakened accordingly. As a result, the OIS carrier 120 deviates from the ball 160, or the OIS carrier 120 does not move as intended, thereby deteriorating the operation performance.

In order to effectively overcome this problem, the yoke 170 of the present disclosure is provided not only at positions corresponding to the first and second magnets 130-1, 130-2 but also at positions corresponding to the moving regions of the first and second magnets 130-1, 130-2 by OIS operation as shown in FIG. 2, so that the attractive force may be effectively applied to the overall moving regions of the first and second magnets 130-1, 130-2. Also, the yoke 170 has an integrated form.

Since the yoke 170 is implemented as an integrated yoke 170 as described above, it is more precise and easier to mount the yoke 170 to the base frame 110 and to align the position of the yoke with the magnet 130. In addition, since the area for generating the attractive force to the magnet 130 may be expanded even though the magnet 130 is moved due to the OIS operation, it is possible to more effectively prevent the OIS carrier 120 from deviating from the ball 160.

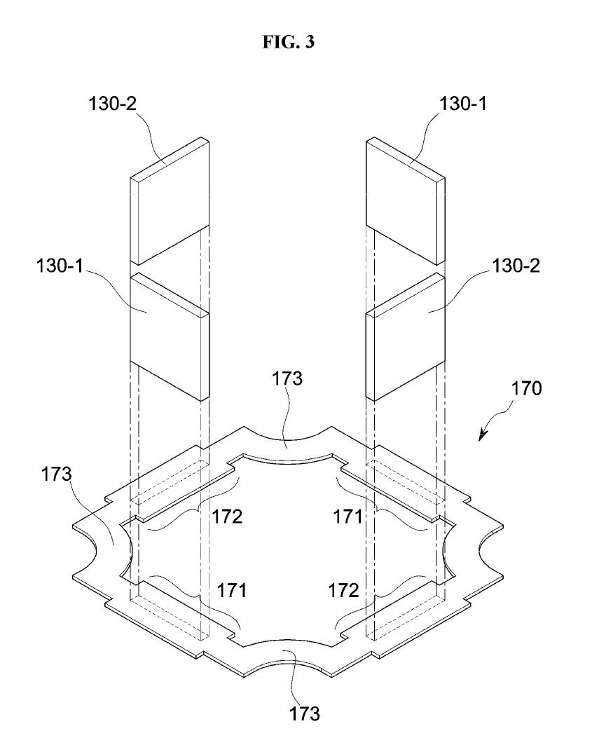

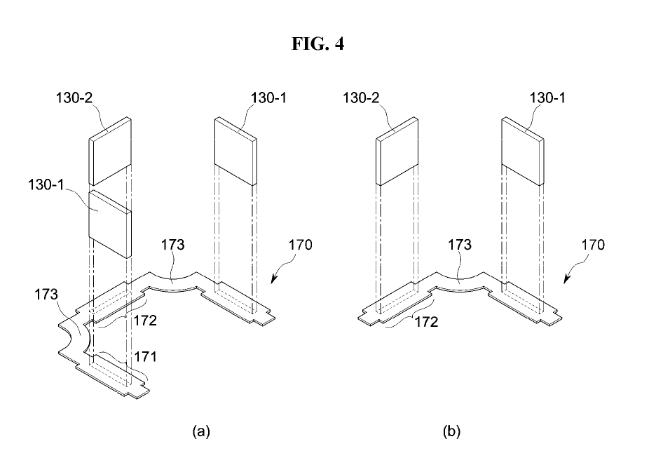

FIGS. 3 and 4 are diagrams showing the detailed configuration of the yoke 170 according to embodiments of the present disclosure. As shown in FIG. 3, the yoke 170 according to an embodiment of the present disclosure may include a first part 171, a second part 172, and a connection part 173. The first part 171 is a portion of the yoke 170 having a width or magnitude corresponding to the moving region of the magnet 130-1 by the OIS operation, and the second part 172 is a portion of the yoke 170 having a width or magnitude corresponding to the basic mounting position of the second magnet 130-2 and the moving region of the second magnet 130-2 by OIS operation.

In addition, the connection part 173 is a portion of the yoke 170 connecting the first part 171 and the second part 172. The connection part 173 preferably has a mutually corresponding shape so that an attractive force is uniformly generated at the magnets and the attractive force is generated in the same region even though the first magnet 130-1 and the second magnet 130-2 move by the OIS operation.

In the embodiment in which two first magnets 130-1 and one second magnet 130-2 are provided at the OIS carrier 120 or one first magnet 130-1 and one second magnet 130-2 are provided at the OIS carrier 120, the yoke 170 may be bent or curved at two places or one place as a whole as shown in FIG. 4 so as to correspond to the number and position of the provided magnets.

At this time, the first part 171 and the second part 172 of the yoke 170 are preferably shaped corresponding to the facing surfaces of the first magnet 130-1 and the second magnet 130-2, respectively. If the first part 171 and the second part 172 are shaped corresponding to the facing surfaces of the magnet 130 as above, it is possible to accurately provide an attractive force by the magnetic force. In addition, even though the OIS carrier 120 moves in a rotating direction, the yoke 170 may be aligned or restored to its proper position more effectively.

The yoke 170 generates an attractive force to the OIS carrier 120 to prevent the OIS carrier 120 from deviating from the ball 160, and also functions to restore the OIS carrier 120 to the reference position if the image stabilization operation is completed.

If the yoke 170 is integrally formed according to an embodiment of the present disclosure, an attractive force may be generated in the overall moving path or moving region of the magnet 130, thereby effectively preventing the OIS carrier 120 from deviating from the ball as described above.

In this case, the first part 171, namely a portion of the yoke 170 corresponding to the first magnet 130-1, and the second part 172, namely a portion of the yoke 170 corresponding to the second magnet 130-2, may be implemented to have different shapes from the connection part 173, namely to have relatively greater width or magnitude than the connection part 173 to occupy broader areas. In this case, the attractive force to between the first magnet 130-1 and the first part 171 and the attractive force between the second magnet 130-2 and the second part 172 may be concentrated further, thereby enhancing the restoring force to the reference position.

It may be regarded that the restoring force to the reference location is generated by inducing the attractive force generating direction to the reference position in the relative force relationship. Thus, even though the first part 171 and the second part 172 are implemented to be narrower than the connection part 173, contrary to the above, the restoring force of the OIS carrier 120 to the reference position may be enhanced.

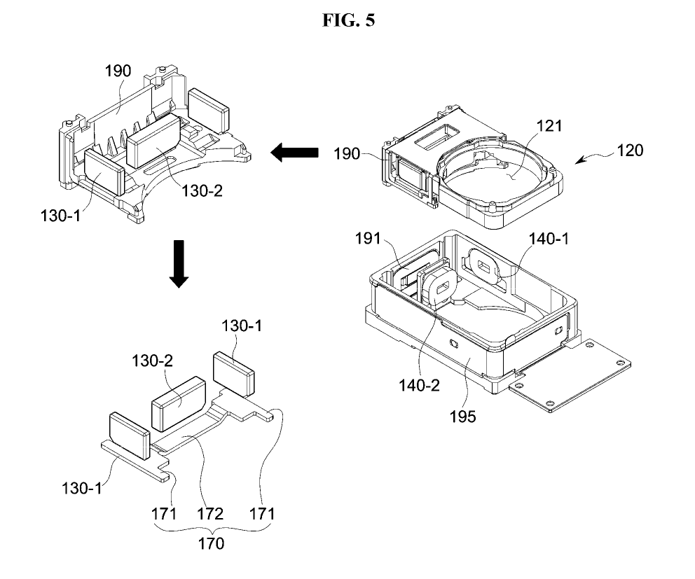

FIG. 5 is a diagram showing an OIS actuator according to still another embodiment of the present disclosure. The OIS actuator depicted in FIG. 5 corresponds to a driving device in which the AF operation and the OIS operation are integrated.

The driving device shown in FIG. 5 includes an AF carrier 190 that moves forward and backward in the optical axis direction inside the housing 195, and an OIS carrier 120 provided on the AF carrier 190 to move in a first direction and/or a second direction perpendicular to the optical axis direction.

In this embodiment, the OIS carrier 120 moves with the AF carrier 190 as a relative fixed body for the OIS operation. Thus, in this embodiment, the base frame 110 of the former embodiment becomes the AF carrier 190, the ball 160 is interposed between the OIS carrier 120 and the AF carrier 190.

The AF carrier 190 moves forward and backward in the optical axis direction (in the Z-axis direction) by the electromagnetic force generated by the AF coil 191 provided at one side of the housing 195. The OIS carrier 120 moves in a direction (the first direction or/and the second direction) perpendicular to the optical axis direction according to the magnitude and direction of the electromagnetic force respectively generated by the first coil 140-1 and the second coil 140-2.

The actuator 100 of the present disclosure may be configured so that the coupling hole 121 in which the lens barrel is coupled is provided at a position deviated in one side from the center portion as shown in FIG. 5. In this case, the internal structure and space of a device to which the actuator 100 is mounted may be more adaptively reflected.

In this case, since the load of the portion of the coupling hole 121, namely the portion of the coupling hole 121 in which the lens barrel (a lens or a lens assembly) is coupled, acts relatively large, it is necessary to make a structural improvement that may more actively apply the attractive force between the OIS carrier 120 and the yoke 170 so that the OIS carrier 120 may maintain the horizontality.

To this end, the first magnet 130-1 and the second magnet 130-2 of the present disclosure are provided at the OIS carrier 120 at a side opposite to the position where the coupling hole 121 is provided. Also, the integrated yoke 170 as described above is provided at the AF carrier 190 so that a strong attractive force acts at the first and second magnets 130-1, 130-2.

In this configuration, the balance between the load of the magnets 130-1, 130-2 and the load of the lens may be improved, and the horizontality of the OIS carrier 120 may be effectively maintained by a strong attractive force of the integrated yoke 170.

As shown in FIG. 5, two first magnets 130-1 may be provided to be symmetrical to each other in a direction parallel to the first direction. In this case, the second magnet 130-2 is arranged in a direction corresponding to the second direction so that the horizontality of the OIS carrier 120 may be more effectively maintained in consideration of the attractive force between the magnet 130 and the yoke 170 and the influence due to the load of the OIS carrier 120. Also, the second magnet 130-2 may be disposed between the first magnet 130-1 and the first magnet 130-1 as shown in FIG. 5.

Further, in order to further minimize the imbalance due to the load, it is preferable that the second magnet 130-2 is provided at a position close to the coupling hole 121 in which the lens barrel is coupled.

As described above, the first magnet 130-1 and the second magnet 130-2 are provided at the OIS carrier 120. Also, in this embodiment, the yoke 170 is provided at the AF carrier 190 corresponding to the base frame 110.

Since the AF carrier 190 moves up and down based on the optical axis direction and the OIS carrier 120 moves in the first direction and/or the second direction perpendicular to the optical axis direction on the AF carrier 190, the carriers are induced to independently move more effectively. Also, the first part 171 and the second part 172 may have different heights to form a step therebetween as shown in FIG. 5 in order to enhance the efficiency in mounting other components.

Meanwhile, the actuator 100 of the present disclosure may include an image sensor such as a CMOS and a CCD or an image processor for converting a light signal input through a lens into an electrical signal. Also, the actuator 100 may further include a filter 185 provided between the lens and the image sensor (processor) to filter the light signal.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first”, “second”, “upper” and “lower” are merely conceptual terms used to relatively identify components from each other, and thus they should not be interpreted as terms used to denote a particular order, priority or the like.

The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

1. An optical image stabilization (OIS) actuator, comprising:
a base frame;
an OIS carrier disposed on the base frame so that a lens barrel is to be coupled thereto;
a first magnet and a second magnet respectively provided to the OIS carrier in a first direction and a second direction, which are orthogonal to each other;
a first coil and a second coil respectively provided to face the first and second magnets to generate an electromagnetic force to the first and second magnets;
a ball interposed between the base frame and the OIS carrier; and
a yoke formed integrally and provided to the base frame at a location corresponding to the first and second magnets to generate an attractive force to the first and second magnets.

2. The OIS actuator according to claim 1, wherein the yoke includes:
a first part corresponding to a region of the first magnet;
a second part corresponding to a region of the second magnet; and
a connection part connecting the first part and the second part.

3. The OIS actuator according to claim 2, wherein the first part and the second part of the yoke are shaped corresponding to facing surfaces of the first and second magnets, respectively.

4. The OIS actuator according to claim 3, wherein the first part and the second part of the yoke are shaped different from the connection part.

5. The OIS actuator according to claim 2, wherein the OIS carrier has a coupling hole formed at a location deviating from a center portion thereof so that the lens barrel is to be coupled therein; and
the first and second magnets are provided at a side opposite to the coupling hole.

6. The OIS actuator according to claim 5, wherein the first magnet includes two magnets symmetrical to each other based on the first direction, and
the second magnet is provided between the two magnets of the first magnet.

7. The OIS actuator according to claim 6, wherein the first part and the second part of the yoke have different heights to form a step therebetween.
